(19) United States
(12) Patent Application Publication
(10) Pub. No.: US 2017/0236208 A1
(43) Pub. Date: Aug. 17, 2017

(54) SYSTEM AND METHOD FOR THE AUTOMATIC GENERATION AND MEDIATION OF A PERSONALIZED MICRO INSURANCE POLICY OFFER

(71) Applicant: Tamas Kovacs, Budapest (HU)

(72) Inventor: Tamas Kovacs, Budapest (HU)

(21) Appl. No.: 15/043,592

(22) Filed: Feb. 14, 2016

(51) Int. Cl. G06Q 40/08; G06Q 20/40

(52) U.S. Cl. CPC G06Q 40/08; G06Q 20/405

(57) ABSTRACT

A computer-implemented system and method for automatic generation and mediation of a personalized, short term insurance policy offer is disclosed. The method enables users to identify a service or activity within the system, and request, receive, and accept personalized, short-term accident insurance policy offers covering the identified activity or service. Users of the system and method can identify, request, receive and accept said insurance policy offers through a user interface. The system and method combines information about an identified service or activity; information about the user; and information provided by insurance providers; in order to mediate a direct, personalized offer from insurance companies to the user.

### CROSS-REFERENCE TO RELATED APPLICATIONS

Not Applicable

### BACKGROUND OF THE INVENTION

### Field of the Invention

This invention relates to the insurance industry in general, more specifically to automatically generated short-term insurance policies, providing accident insurance coverage for a pre-specified service or activity.

Healthcare and related insurance is costly, and currently there are no fast and efficient ways to provide short-term, case-by-case natured small insurance offers to people. Our invention aims to overcome this by providing a platform where insurance providers can offer short-term insurance policy offers with coverage for a specified one-time service or activity, like a go-kart race or a dental procedure for example.

### BRIEF SUMMARY OF THE INVENTION

The invention disclosed here is a novel computer-implemented business method consisting of a System to which three types of parties register, and a Method which feeds, queries, operates and utilizes data that is fed to said System. Said Method provides a user interface in the form of a smartphone application, through which end users can accept short term accident insurance policy offers in relation to a specified service or activity. Said specified service or activity can be of any nature, for which an insurance company agrees to provide insurance coverage for (for example: a 6 minute go-kart race, bungee jumping, summer camp, or a dental procedure or dental service).

### BRIEF DESCRIPTION OF THE SEVERAL VIEWS OF THE DRAWING

Not Applicable

### DETAILED DESCRIPTION OF THE INVENTION

Embodiment of the current invention provides a System and Method to which three distinct parties can register. The System stores all registry information from registrant parties and categorizes information by unique identification numbers, given to each registrant. The three categories of registrant parties are Service Providers (“Service Provider” henceforth), Insurance Providers (“Insurance Provider” henceforth) and End Users (“End Users” henceforth).

Service Providers are companies or persons who register their services in the System so that their customers can buy short-term insurance policies, with coverage for the time of their services. These services can be of any type, including at least those that carry the risk of an accident, and those for which at least one Insurance Provider agrees to provide insurance coverage for.

Upon registration, Service Providers have to fill a form, having at least the following elements: company address, company name, location of service, company registry number, name of the official representative of the company, preferred contact telephone number, preferred contact email address.

Registered Service Providers can register their different services (e.g. a 6 min go-kart race; a jump with bungee jumping; a dental care procedure; etc. . . . ). Upon registering a service, Service Providers have to fill a registry form for services having at least the following elements: name of service, expected duration of service, location of service, nature of service, potential risks of the service. For defining the nature and the potential risks of service a tag system is used, where Service Providers have to describe their registered service to their best knowledge, using pre-given tags and by filling out additional pre-defined input data fields aimed at giving the best possible description of the given service.

Insurance Providers are insurance companies who offer their short term insurance policies to the End Users for a given service, provided by Service Providers through the smartphone application.

Upon registration, Insurance Providers have to fill a form, having at least the following elements: company address, company name, company registry number, name of the official representative of the company, preferred contact telephone number, preferred contact email address.

Registered End Users can identify a registered service or activity in our system, and can request, receive, accept and buy short-term insurance policies through a user interface. Any person can register as an End User.

Upon registration, End User have to fill a registration form, having at least the following elements: birth date, gender, payment method and payment information, and additionally social security number or any official, national identification number.

End User can use the application to identify an insurable service or activity which is provided by a registered Service Provider. When a service or activity is chosen by the End User, the disclosed Method queries and matches registrant information of the End User, the Service Provider, the registered service or activity (registered by the Service Provider) and the registered Insurance Providers. Through the matching process Insurance Providers can automatically provide personalized insurance policy offers to the End User, providing insurance coverage for the identified service or activity. End User can choose and accept any of the provided insurance policy offers, and engage in a contractual relationship with the Insurance Provider.

Identification of a service or activity in the System happens through the user interface in the form of a smartphone application. Identification methods include at least: QR code reading, NCR communication or searching the System by a keyword search.

When a specified service or activity is identified by the End User, the said System and Method automatically matches registry information of the End User, with registry information of the identified service or activity which was registered by a Service Provider. Then said System and Method mediates the matched information to the Insurance Provider and receives automatically calculated offers from said Insurance Providers. The user interface lists all automatically calculated offers for the End User. End User can review the contents of the offers (including at least the Terms & Conditions of Agreement, the duration and other details of the insurance coverage, and price) and can accept only one offer at a time. When End User accepts an offer, End User and Insurance Provider engage in a contractual relationship and the insurance fee of the offer is transferred from End User (method depends on pre-selected payment method) to the Insurance Provider.

We claim:

1. A System and Method for automatic generation and mediation of a personalized, short term insurance policy offer relating to—and providing insurance coverage for an identified, specific service or activity, the System and Method comprising: a System which assigns unique identification numbers to registrants and categorizes all registry information based on said unique identification numbers; and a Method with a user interface in the form of a smartphone application, which can identify a specific service or activity and can combine registry information of said specific service or activity with registry information of the registered End User. The Method then mediates this information to Insurance Providers. Insurance Providers automatically calculate an insurance policy offer, offered to End User, through the System and Method.

2. A System and Method as defined in claim 1, has means for creating and mediating personalized short-term insurance policy offers through any service or activity identification method, including at least: reading a QR code; NCR communication; by choosing a service or activity from a list of offers offered by said System and Method; searching for a service or activity in the user interface of said System and Method

3. A System and Method as defined in claim 1, has means for matching identified service or activity related registry information with End User related registry information and automatically mediate those to registered Insurance Providers, in order to instantly create a personalized, specific service or activity related, one time insurance policy offer.

4. A System and Method as defined in claim 1, has means for acting as a mediator between End User and Insurance Provider, automatically binding them into a contractual relationship, when End User accepts an offer made by the Insurance Provider.

5. A System and Method as defined in claim 1, has means for automatically charge the End User for the price of the accepted insurance policy offer and initiate a payment transfer to the Insurance Provider, based on the payment method set by the End User.
